(19) United States
(12) Patent Application Publication
(10) Pub. No.: US 2009/0161145 A1
(43) Pub. Date: Jun. 25, 2009

(54) SYSTEM AND METHOD FOR REPRODUCING AN IMAGE USING A MULTI-FUNCTION PERIPHERAL (MFP)

(75) Inventors: Mark Van Regenmorter, Irvine, CA (US); Brent Richtsmeier, Laguna Niguel, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Suwon City (KR)

(21) Appl. No.: 11/962,000

(22) Filed: Dec. 20, 2007

(51) Int. Cl. G06F 15/00

(52) U.S. Cl. 358/1.15

(57) ABSTRACT

System and method for reproducing an image using a multi-function peripheral (MFP) is disclosed. In one aspect, the method comprises receiving a source page at a MFP, wherein at least a portion of the source page is to be reproduced. The method further comprises displaying an editable electronic image of the source page in a display of the MFP along with a measuring element indicating the size of the editable image.

### BACKGROUND OF THE INVENTION

1. Field of the Invention

The invention relates to multi-function peripherals (MFPs). More particularly, the invention relates to reproducing an image, e.g., making copies using a MFP.

2. Description of the Related Technology

A user often needs to copy a document onto a page of a size different from the original document. To meet this need, existing MFP devices have menu options such as fit-to-page and/or reduce/enlarge percentages to a user to fit the original document in the output page. The reduce/enlarge percentage feature is inconvenient because a user can hardly calculate the correct size for the printed image. Also, the existing fit-to-page and/or reduce/enlarge percentages do not provide a preview of the final copy to be made under the current settings. Therefore, it is desirable to improve the existing user interface for copy jobs.

### SUMMARY OF CERTAIN INVENTIVE ASPECTS

The system, method, and devices of the invention each have several aspects, no single one of which is solely responsible for its desirable attributes. Without limiting the scope of this invention, its more prominent features will now be briefly discussed.

In one aspect, a method of reproducing an image using a multi-function peripheral (MFP) is disclosed. The method comprises receiving a source page at a MFP, wherein at least a portion of the source page is to be reproduced. The method further comprises displaying an editable electronic image of the source page in a display of the MFP along with a measuring element indicating the size of the editable image.

In another aspect, a method of reproducing an image using a multi-function peripheral (MFP) is disclosed. The method comprises receiving a source page at a MFP, wherein at least a portion of the source page is to be reproduced on a destination page. The method her comprises displaying an editable electronic image of the source page in a display of the MFP along with an outline over the editable image of the source page, the outline indicating the location and size of the destination page relative to the editable image when the editable image is reproduced on the destination page.

In another aspect, a multi-function peripheral (MFP) device is disclosed. The device comprises a display configured to, upon receiving a request to reproduce a source page, display an editable electronic image of the source page together with a measuring element indicating the size of the editable image.

In another aspect, a multi-function peripheral (MFP) device is disclosed. The device comprises a display configured to, upon receiving a request to reproduce a source page onto a destination page, display an editable electronic image of the source page together with an outline over the editable image of the source page, the outline indicating the location and size of the destination page relative to the editable image when the editable image is reproduced to the destination page.

In another aspect, a multi-function peripheral (MFP) device is disclosed. The device comprises means for receiving a source page, wherein at least a portion of the source page is to be reproduced onto a destination page. The device further comprises means for displaying an editable electronic image of the source page along with an outline over the editable image of the source page, the outline indicating the location and size of the destination page relative to the editable image when the editable image is printed to the destination page.

### BRIEF DESCRIPTION OF THE DRAWINGS

FIG. 1 is an overview illustrating one embodiment of a system for copying a document using a MFP.

FIG. 2 illustrates an exemplary view of the control panel, of FIG. 1, which provides a preview capability to a user for copying jobs.

FIG. 3 is a flowchart of one embodiment of a method of making a copy using a MFP.

FIGS. 4A and 4B illustrate an exemplary view of another embodiment of the control panel, of FIG. 1, which provides a preview capability to a user for copying jobs, and the corresponding destination page as printed out.

FIGS. 5A and 5B illustrate an exemplary view of another embodiment of the control panel, of FIG. 1, which provides a preview capability to a user for copying jobs, and the corresponding destination page as printed out.

FIGS. 6A and 6B illustrate an exemplary view of another embodiment of the control panel, of FIG. 1, which provides a preview capability to a user for copying jobs and the destination page when being printed.

FIGS. 7A and 7B illustrate an exemplary view of another embodiment of the control panel, of FIG. 1, which provides a preview capability to a user for copying jobs and the destination page when being printed.

FIGS. 8A and 8B illustrate an exemplary view of another embodiment of the control panel, of FIG. 1, which provides a preview capability to a user for copying jobs and the destination page when being printed.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements. In the following description, specific details are given to provide a thorough understanding of the disclosed methods and apparatus. However, it will be understood by one of ordinary skill in the technology that the disclosed systems and methods may be practiced without these specific details. For example, electrical components may be shown in block diagrams in order not to obscure certain aspects in unnecessary detail. In other instances, such components, other structures and techniques may be shown in detail to further explain certain aspects.

It is also noted that certain aspects may be described as a process, which is depicted as a flowchart, a flow diagram, a structure diagram, or a block diagram. Although a flowchart may describe the operations as a sequential process, many of the operations may be performed in parallel or concurrently and the process may be repeated. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Certain embodiments as will be described below provide a preview capability in a multi-function peripheral (MFP), allowing a user to visually recognize the size of the printed image and adjust the percentage as necessary to fit the user needs. In one embodiment, a control panel of the MFP displays an image of the document to be copied with graphical rulers, thereby indicating the size of the image. A user may determine the reduction/enlargement percentage after previewing the image of the document with the rulers. In another embodiment, the control panel further provides advanced edit options, allowing a user to edit a preview image of the document to be printed, and to print the edited image to the output page after previewing the edited image in the control panel. Though a MFP is used as an example for illustration, the embodiments are applicable to other devices having a control panel and providing copy capability, such as a copy machine.

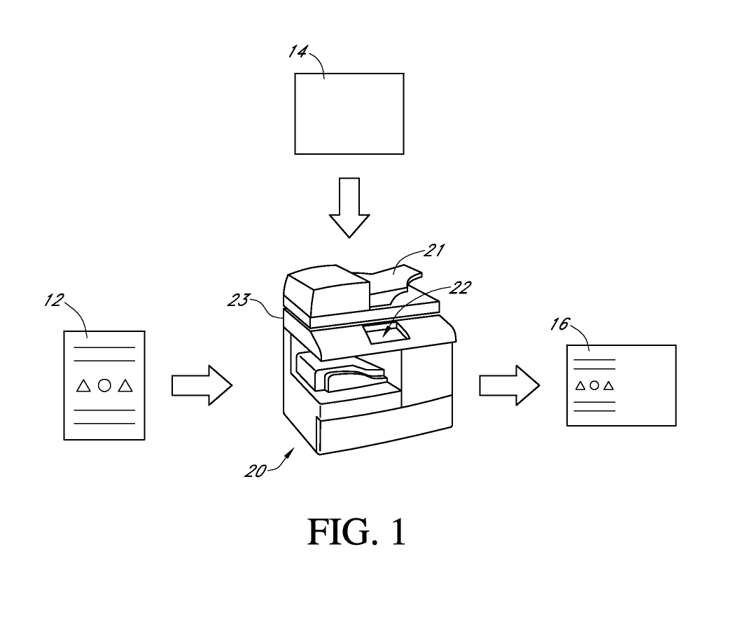

FIG. 1 is an overview illustrating one embodiment of a system for copying a document using a MFP. A MFP refers to an equipment that handles two or more of the following functions: printing, emailing, copying, or faxing. It is also called a multi-function product, a multi-function printer, a multi-function device, an All-in-One device, etc.

The MFP 20 comprises a control panel 22. A control panel may be included in various devices to provide a user interface to control and operate the devices. Via the control panel, a user may, for example, change and save settings at the device and access other functions provided. Typically, a control panel has a menu interface. The user may look at a menu, select one of the controls (such as a menu tab, a menu item, an icon or a button) on display, and go to the next screen associated with the selected control. A control may be selected when, for example, a user clicks on the control.

The MFP 20 may further comprise a unit for receiving a hardcopy document for copying jobs. The receiving unit may be, for example, a feed tray 21, or a glass plate 23 as shown in FIG. 1 where a user may place the page to be copied.

In the exemplary embodiment, the MFP 20 receives a source page 12 at least a portion of which is to be copied onto a destination page 14. The destination page 14, after the copying is completed, is shown and may also be referred to as a printed page 16.

The source page 12 may be anything that may be copied on a copy machine or a MFP, including, but not limited to, a picture, a document, or a page of a book. The source page is typically a hardcopy for copying jobs, but may also be an electronic image in some applications.

The destination page 14 is, for example, an output tray paper. The destination page 14 is typically blank before being printed. The destination page 14 may or may not have the same page size as the source page 12. In one embodiment, the MFP 20 is pre-loaded with more than two sizes of papers. A user selects one from the available paper sizes in the control panel 22 as the destination page 14. The destination page 14 may also be loaded manually by a user.

In the exemplary embodiment, a typical copying process may be described as follows. The MFP 20, upon receiving a source page 12 from a user, scans the source page 12 into an electronic image stored in, for example, a memory of the MFP 20. The MFP 20 displays the electronic image to the user for preview along with a set of controls for the user to edit the electronic image. While the electronic image is being edited, the display of the electronic image is promptly updated to reflect any changes to the electronic image. At some point, the user confirms that the electronic image is ready to be printed after previewing the electronic image. The MFP 20 then prints the electronic image onto the destination page 14. The destination page 14 now is referred to as a printed page 16.

Though the electronic image of the source page is originally the same as the source page 12, the electronic image may be edited before being printed onto the destination page 14. Therefore, the printed page 16 does not necessarily include the same image as the source page 12 with the same size. For example, the printed page 16 may include only a portion of the source page 12. The printed page 16 may further include a blank portion in addition to a portion of the source page 12 as shown in the printed page 16 of FIG. 1. Further, the portion of the source page 12 may be reduced/enlarged in size when being printed to the destination page 14.

The MFP 20 may further comprise a control unit (not shown) configured to control the operation of the MFP 20. In one embodiment, the control unit is a processor which may be any suitable general purpose single- or multi-chip microprocessor, or any suitable special purpose microprocessor such as a digital signal processor, microcontroller, or a programmable gate array. As is conventional, the processor may be configured to execute one or more software applications.

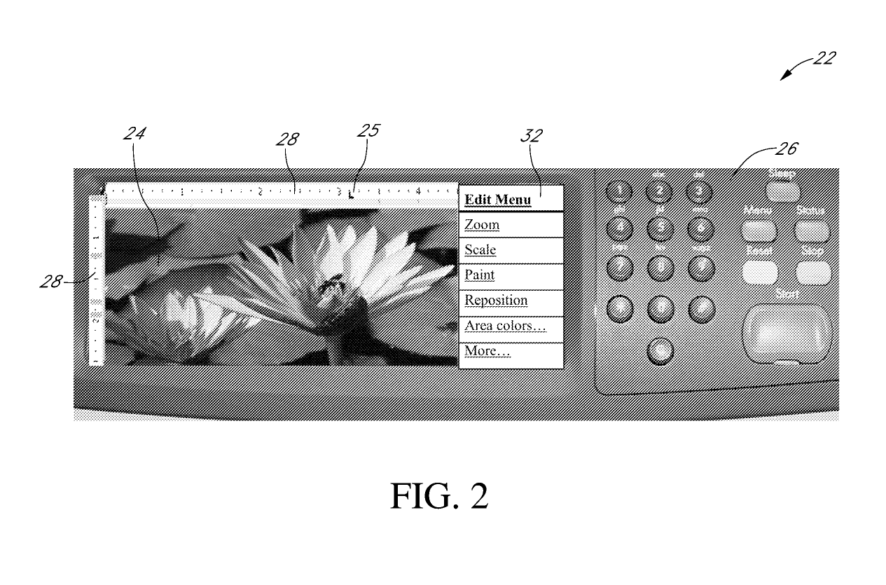

FIG. 2 illustrates an exemplary view of the control panel 22 which provides a preview capability to a user for copying jobs. The control panel 22 provides a user interface to control and operate the device. The control panel comprises a display area 24 and a set of buttons 26. The display 24 shows an editable image, which is a scanned copy of the source page, and a menu 32. The menu 32 and the buttons 26 provide controls for a user to edit the editable image. In certain embodiments, the display area 24 is a touch screen.

In the exemplary embodiment, ruler marks 28 are displayed in the display 24 along sides of the editable image of the source page. The size of the editable image of the source page as measured by the ruler marks 28 indicates the size of the electronic image when being printed to the destination page. The measurement information provided by ruler marks 28 thus allows a user to visually recognize the size of the electronic image when being printed. Since a user usually knows the size of the destination page, the user is able to visually recognize, e.g., whether the electronic image is too big to be printed to the destination page.

In one embodiment, a user may look at the control panel 22 as shown in FIG. 2 and determines that the editable image of the source page is larger than the page size of the destination page. The user then uses the menu 32 to edit the editable image of the source page, e.g., reducing the editable image of the source page to a certain size. The editable image is then displayed with the new size, thus allowing the user to determine whether the editable image now fits well with the destination page. At some point, the user confirms that the editable image is ready to be printed after previewing the editable image. The MFP then prints the editable image onto the destination page.

Optionally, the display 24 may further include one or more boundary indicators 25 displayed along the ruler marks 28 to indicating the size of the destination page. Depending on the applications, the display 24 may include only one boundary indicator 25 indicating the length or width of the destination page, or the display 24 could include more than one boundary indicators such that both the length and width of the destination page are visually indicated. With the boundary indicators 25, a user can visually recognize the relative size of the editable image of the source page to the destination page. The relative size of the editable image to the destination page is more convenient to a user in certain applications, such as, determining the right reduction/enlargement percentage to fit the editable image of the source page to the destination page.

In the exemplary embodiment, the ruler marks 28 are displayed in display 24. However, the embodiment should not be limited thereto. The ruler marks 28 may also be physically formed on the sides of and outside the display 24. For example, the ruler marks 28 may be formed by etching the marks into the front panel 22, or by fixing rulers to the surface of the front panel.

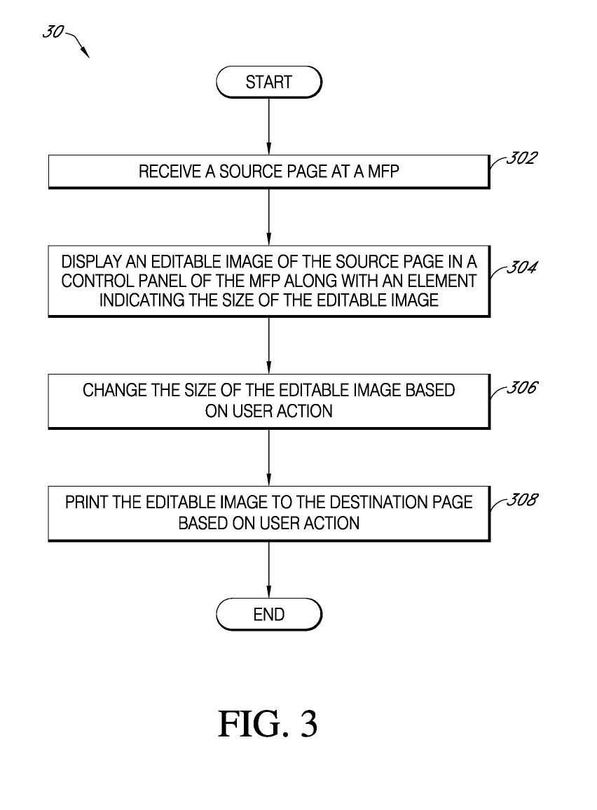

FIG. 3 is a flowchart of one embodiment of a method of making a copy using a MFP. The exemplary method may be performed on, for example, a MFP as described in FIGS. 1 and 2. Depending on the embodiment, certain steps of the method may be removed, merged together, or rearranged in order. The general principle of the exemplary method will be described as below.

The method begins at a block 302, where the MFP receives a source page to be copied to a destination page. In the exemplary embodiment, the source page is a hardcopy. The MFP scans the source page into an electronic image

Next at a block 304, the MFP displays an electronic image of the source page in a control panel along with an element indicating the size of the electronic image. The electronic image is editable. The element indicating the size of the electronic image may be ruler marks along the electronic image as described in FIG. 2.

Moving to a block 306, the MFP edits the size of the editable image based on user action. The editing may be, for example, enlarging/reducing the size of the editable image using controls on the control panel of the MFP. The display of the editable image is updated each time the user edits the image such that the user can review changes made to the editable image. A user may repeat the process of 306 multiple times until the user is satisfied with the editable image after previewing the editable image in the control panel.

Next at a block 308, the MFP prints the editable image to the destination page based on user action.

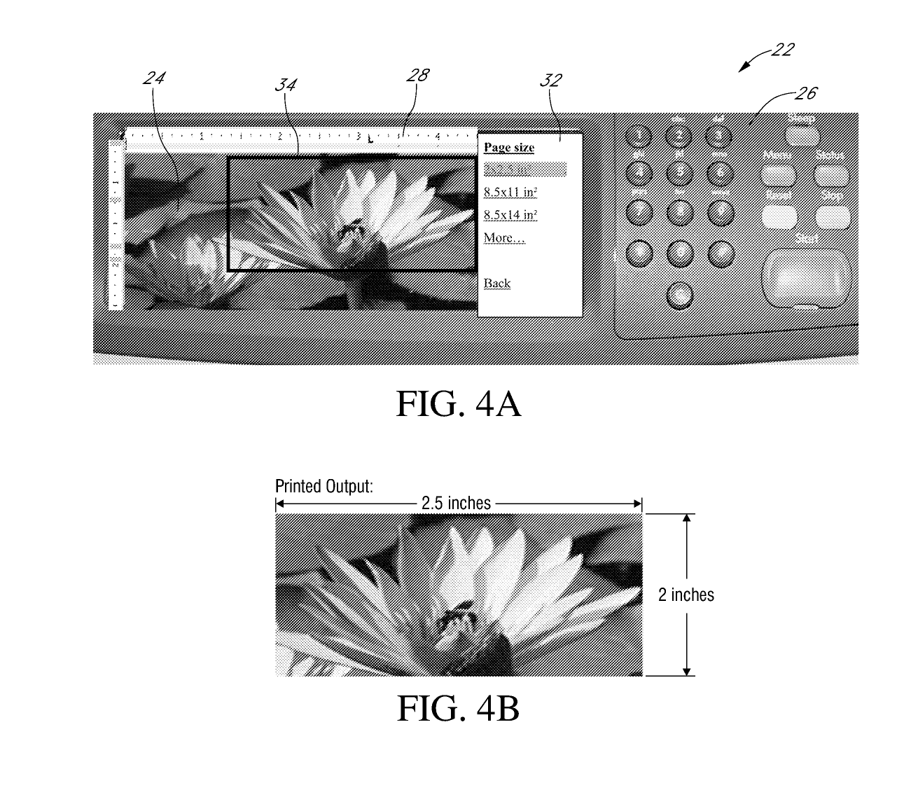

In the exemplary method, the element indicating the size of the electronic image is ruler marks along the electronic image as described in FIG. 2. It should be noted that the element indicating the size of the electronic image may be implemented in other ways as will be illustrated below with regard to FIGS. 4A and 4B.

Also, the block 306 in the exemplary method allows a user to edit the size of the editable image. It will be appreciated that the block 306 may be revised to allow a user to edit the editable image in various ways as provided by the control panel to obtain customized printout on the destination page. The display of the editable image is updated each time the user edits the image such that the user can review changes made to the editable image. FIGS. 4A-8B as will be described below provide various options to a user to edit the source page while making a copy of the source page on the MFP.

FIG. 4A illustrates an exemplary view of another embodiment of the control panel 22 which provides a preview capability to a user for copying jobs. It should be noted that though FIG. 4A shows ruler marks 28 in the display 24 along sides of the editable image of the source page, ruler marks 28 are not necessary to this embodiment and thus may be removed without affecting the basic operation of this embodiment.

In this embodiment, a user may add an editable outline, e.g., an output box 34, over the editable image of the source page. The output box 34 indicates the location and size of the destination page relative to the editable image when the editable image is printed to the destination page. The MFP is configured to print only the portion of the editable image of the source page falling within the output box 34. Therefore, the control panel 22 allows a user to visually recognize which portion of the editable image is chosen to appear on the destination page when being printed. Scrollbars may be used if the output box 34 is greater than the editable image.

A user may use the menu 32 to change the size of the destination page. When a different size of the destination page is selected, the output box 34 in the display is promptly updated to reflect the new size. At some point, the user confirms that the editable image is ready to be printed after previewing the editable image with the output box 34. The MFP then prints the editable image onto the destination page.

In one embodiment, the available sizes displayed in the menu 32 also depend on the destination pages available at the MFP. If destination pages of a particular page size are unavailable, a user will not be able to select the particular page size in the menu 32 as the destination page.

In FIG. 4A, the page size of 2×2.5 inch is highlighted, indicating that the editable image of the source page is going to be printed to a destination page of that page size. FIG. 4B shows the destination page printed with the selection made in FIG. 4A. As shown, the destination page is 2×2.5 inch. In addition, only the portion of editable image falling within the output box 34 is printed. The control panel of FIG. 4A provides a good preview of the printed output of FIG. 4B.

In the exemplary embodiment, the output box 34 may be changed to a different size if the destination page of a different size is selected using the menu 32. It should be noted that the output box 34 may be edited in various ways. For example, the menu 32 may provide a control for a user to move the location of the output box 34 such that a particular portion of the editable image of the source page may fall within the output box 34, thereby being printed.

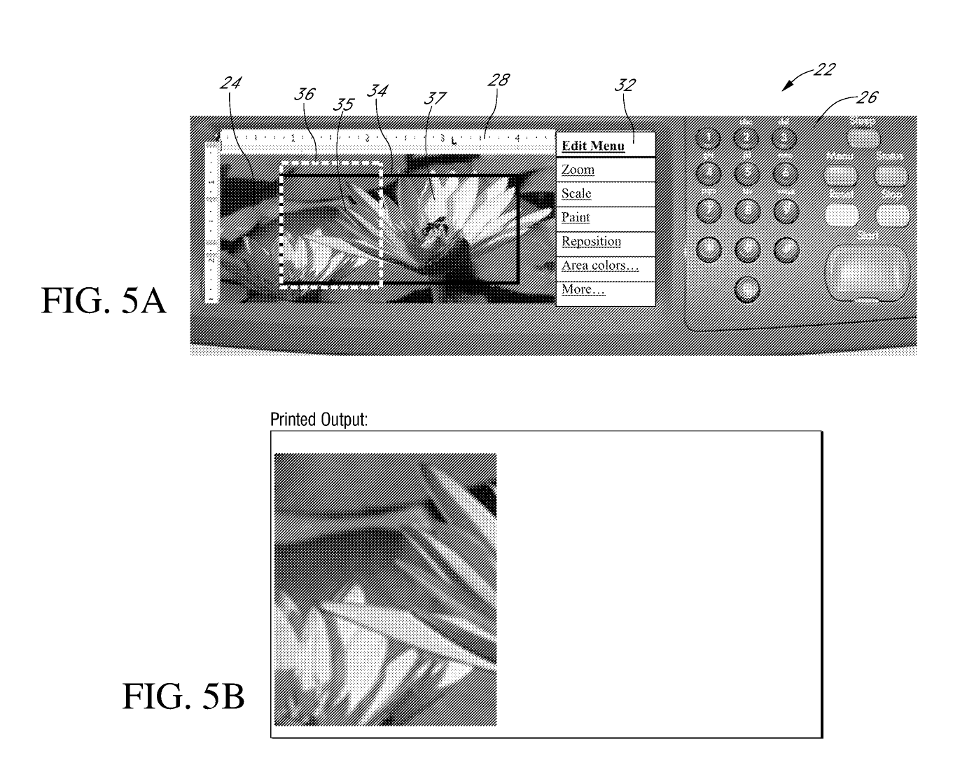

FIG. 5A illustrates an exemplary view of another embodiment of the control panel 22 which provides a preview capability to a user for copying jobs. A user may further add an editable print area 36 over the editable image of the source page along with the output box 34. The print area 36 may be marked by any suitable lines or curves including, but not limited to, broken lines as shown in FIG. 5. The print area 36 may be of any suitable shape.

The print area 36 indicates the portion of the editable image of the source page that is selected to be printed. Together with the output box 34 which indicates the location and size of the destination page relative to the editable image when the editable image is printed to the destination page, the print area 36 determines the portion of the editable image of the source page that appears on the destination page when being printed.

FIG. 5B shows the destination page when being printed with the selection made in FIG. 5A. As illustrated in FIG. 5B, only the portion 35 of the editable image that falls within both the print area 36 and the output box 34 is printed to the destination page. The portion 37 of the editable image that falls within the output box 34 but outside the print area 36 is not printed. Instead, the area corresponding to the portion 37 in the output box 34 is left blank on the printed destination page.

It should be noted that the print area 36 may be edited in various ways. For example, the menu 32 may provide a control for a user to move the location of the print area 36 such that a particular portion of the editable image of the source page may fall within the print area 36. The size and shape of the print area 36 may also be edited.

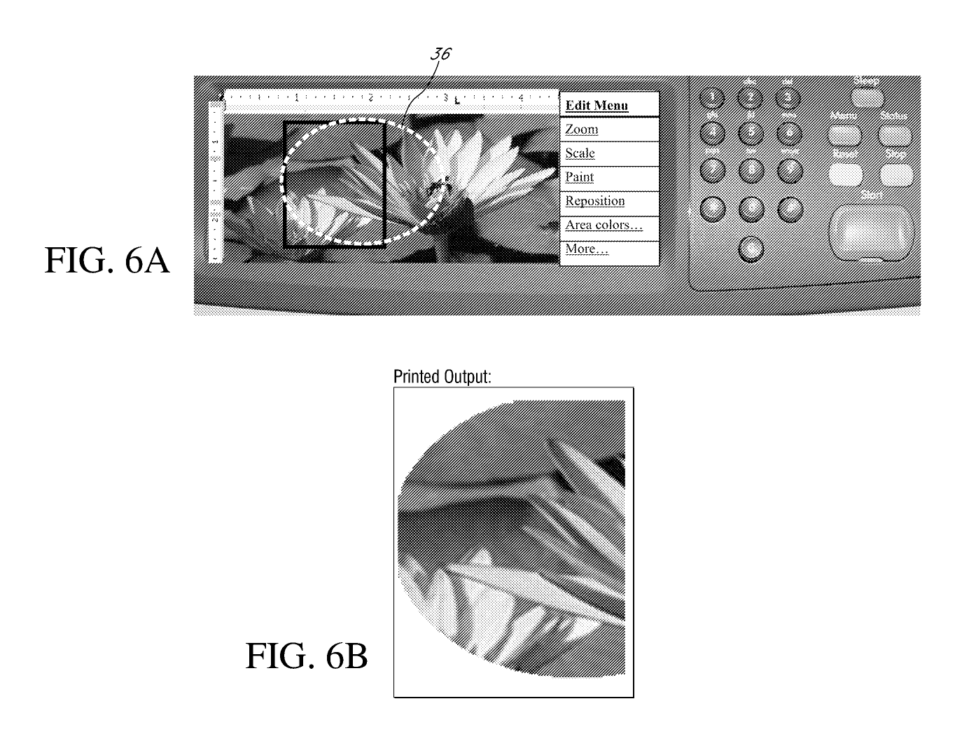

In one embodiment, a list of pre-defined shapes for print areas such as ovals, stars, and circles may be provided. The user can first select one of the pre-defined shapes as the print area and then edit the print area. FIGS. 6A and 6B shows an example in which an oval print area 36 is added to the editable image of the source page.

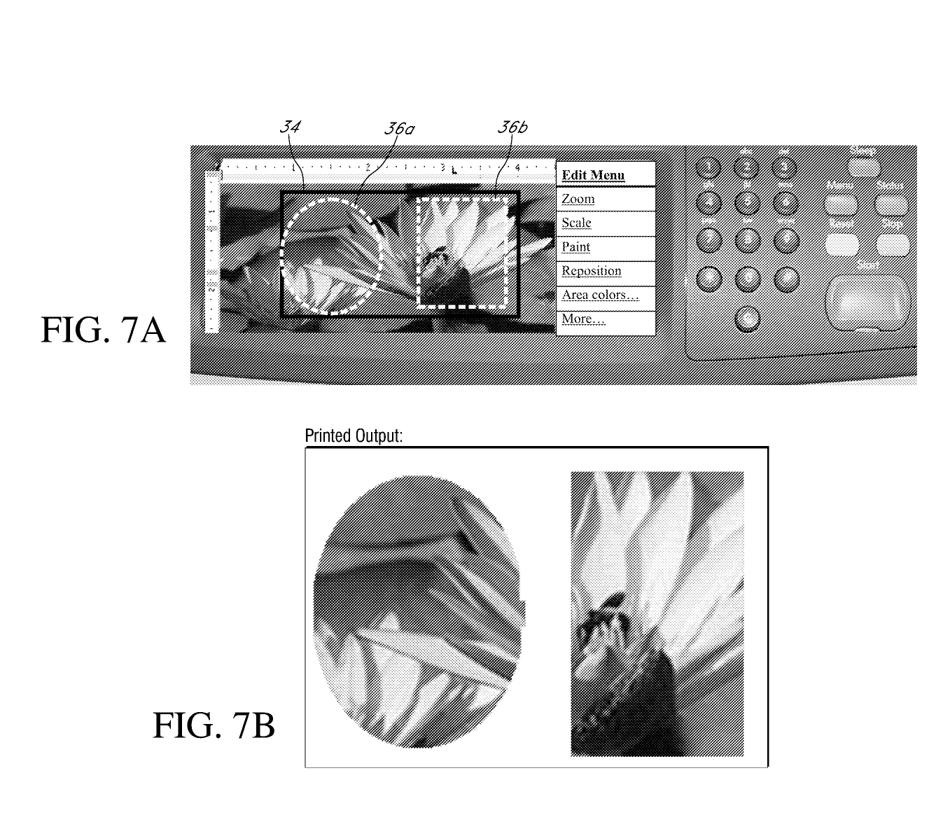

FIGS. 7A and 7B illustrate an exemplary view of another embodiment of the control panel 22 which provides a preview capability to a user for copying jobs and the destination page when being printed. As shown, a user may add multiple print areas to the editable image of the source page. In FIG. 7A, an oval print area 36a and a rectangle print area 36a are placed within an output box 34. FIG. 7B shows the destination page when being printed with the selection made in FIG. 7A. This embodiment allows a user to combine multiple portions of the source page to form a new image to be printed to the destination page.

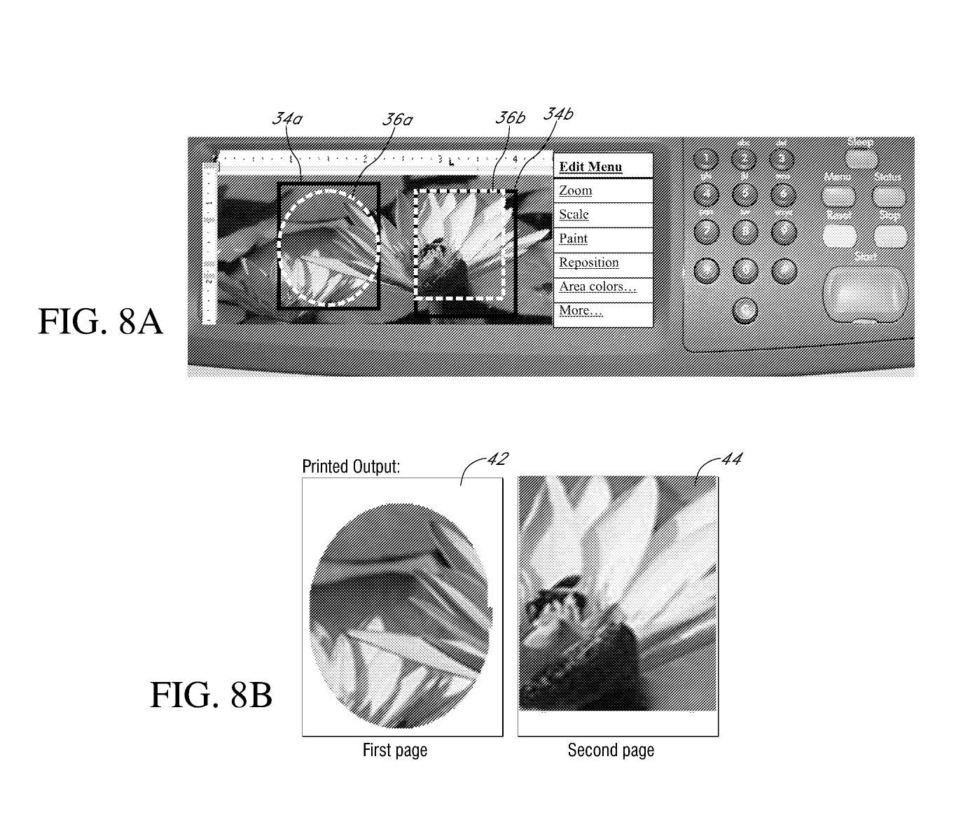

FIGS. 8A and 8B illustrate an exemplary view of another embodiment of the control panel 22 which provides a preview capability to a user for copying jobs and the destination page when being printed. As shown, a user may add multiple output boxes to the editable image of the source page. Each output box represents one destination page.

In FIG. 8A, a first output box 34a and an oval print area 36a in FIG. 8A define the printout of a first destination page. A second output box 34b and a rectangular area 36b define the printout of a second destination page. FIG. 5B shows the first and second destination page 42 and 44 when being printed with the selection made in FIG. 8A. The exemplary embodiment enables a user to add multiple output boxes on the editable image of the source page, thereby copying a source page into multiple pages. The multiple output boxes may have different paper sizes, allowing a user to copy a source page into multiple pages of different page sizes.

The foregoing embodiments provide in a control panel of a MFP an improved graphical user interface (GUI) for copying jobs. Though a control panel is used as an example, such improved GUI may be incorporated in any display of a MFP. These embodiments provide various editing options to a user. For example, a user may move the print areas and the output boxes using a touch screen by dragging the print areas/output boxes across the screen. A user may crop or tile a portion of the editable image. Other Examples of the image manipulation functions include scaling, fit-to-page, paint functions, cropping, tiling, image build, and various functions included in image edit software.

The foregoing embodiments relate to making a copy of a source page. These embodiments can be easily applied to copying a document including multiple source pages. In one embodiment, each source page is scanned and then individually copied as discussed above. In another embodiment, the first page of the document is copied with the appropriate reduction/enlargement settings adjusted by a user as discussed above. The rest pages of the document are copied with the same reduction/enlargement settings as the first page without further user interaction. This embodiment is especially useful when the pages of the document are of the same size.

The foregoing embodiments provide in a control panel of a MFP an improved graphical user interface for copying jobs. It should be noted that these embodiments may also be applied to provide an improved user interface for printing jobs.

In the foregoing embodiments, a method and a system for making a copy of a source page to a destination page are described. The source page and the destination page are both a hard copy in the illustrating examples. However, these embodiments should not be limited thereto. These embodiments may be applied for reproducing an image of a source page to a destination page, with each of the source page and destination page being a soft copy or hard copy. For instance, the source page may be a soft copy (e.g., an electronic image) that the MFP receives from a user, for example, via an input/output interface or a network connection.

The destination page may also be a soft copy (e.g., an electronic image). For example, in a particular application, a user may want to reproduce a source page as an electronic image (e.g., a PDF file) of a particular page size. The reproduced electronic image may be used for display or be saved for printing at a later time. The working examples of the foregoing embodiments may be used for this particular application with the hard copy destination page being replaced with a soft copy destination page. As a result, the MFP may print a portion of the source page to a soft copy destination page, thus generating an output electronic image having a portion of the source page and being of the same size as the soft copy destination page. The resulting output electronic image, where a soft copy destination page is used, is the same as an electronic image of a resulting destination page where a hard copy destination page is used.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A method of reproducing an image using a multi-function peripheral (MFP), the method comprising:
receiving a source page at a MFP, wherein at least a portion of the source page is to be reproduced; and
displaying an editable electronic image of the source page in a display of the MFP along with a measuring element indicating the size of the editable image.

2. The method of claim 1, wherein the source page is a physical copy or an electronic copy.

3. The method of claim 1, wherein the measuring element comprises ruler marks along the sides of the editable image of the source page.

4. The method of claim 1, further comprising:
after user action, changing the size of the editable image of the source page.

5. The method of claim 4, further comprising:
after user action, printing the editable image of the source page at the changed size to a destination page.

6. The method of claim 5, wherein the destination page is a physical copy or an electronic copy.

7. A method of reproducing an image using a multi-function peripheral (MFP), the method comprising:
receiving a source page at a MFP, wherein at least a portion of the source page is to be reproduced on a destination page; and
displaying an editable electronic image of the source page in a display of the MFP along with an outline over the editable image of the source page, the outline indicating the location and size of the destination page relative to the editable image when the editable image is reproduced on the destination page.

8. The method of claim 7, wherein the destination page is a physical copy or an electronic copy.

9. The method of claim 7, wherein the MFP is configured to print only the portion of the editable image of the source page falling within the outline to the destination page.

10. The method of claim 9, further comprising:
after user action, editing the outline.

11. The method of claim 10, wherein the editing comprises changing the size or location of the outline.

12. The method of claim 7, further comprising:
selecting at least one print area of the editable image of the source page based on user action, the print area indicating the portion of the editable image to be printed; and
displaying a curve marking the at least one print area over the editable image of the source page.

13. The method of claim 12, further comprising:
after user action, printing only a portion of the editable image of the source page falling within the at least one print area and within the outline to the destination page.

14. A multi-function peripheral (MFP) device comprising:
a display configured to, upon receiving a request to reproduce a source page, display an editable electronic image of the source page together with a measuring element indicating the size of the editable image.

15. The device of claim 14, wherein the measuring element comprises ruler marks along the sides of the editable image of the source page.

16. The device of claim 15, wherein the ruler marks are physically formed outside a display area of a control panel of the display, or displayed in a display area of a control panel of the MFP.

17. The device of claim 14, further comprising a control panel configured to:
change the size of the editable image of the source page based on user action; and
print the editable image of the source page at the changed size to a destination page based on user action.

18. The device of claim 17, wherein the destination page is a physical copy or an electronic copy.

19. A multi-function peripheral (MFP) device comprising:
a display configured to, upon receiving a request to reproduce a source page onto a destination page, display an editable electronic image of the source page together with an outline over the editable image of the source page, the outline indicating the location and size of the destination page relative to the editable image when the editable image is reproduced to the destination page.

20. The device of claim 19, wherein the destination page is a physical copy or an electronic copy.

21. The device of claim 19, wherein the MFP is configured to print only the portion of the editable image of the source page falling within the outline to the destination page.

22. The device of claim 21, further comprising a control panel configured to edit the outline based on user action.

23. The device of claim 19, further comprising a control panel configured to:
select at least one print area of the editable image of the source page based on user action, the print area indicating the portion of the editable image to be printed; and
display a curve marking the at least one print area over the editable image of the source page.

24. The device of claim 23, wherein the control panel is further configured to:
print only a portion of the editable image of the source page falling within the at least one print area and within the outline to the destination page based on user action.

25. A multi-function peripheral (MFP) device comprising:
means for receiving a source page, wherein at least a portion of the source page is to be reproduced onto a destination page; and
means for displaying an editable electronic image of the source page along with an outline over the editable image of the source page, the outline indicating the location and size of the destination page relative to the editable image when the editable image is printed to the destination page.
